(19) United States
(12) Patent Application Publication
(10) Pub. No.: US 2024/0312294 A1
(43) Pub. Date: Sep. 19, 2024

(54) GAMING MACHINE AND METHOD FOR DISPLAYING A GAME LOBBY USER INTERFACE

(71) Applicant: Aristocrat Technologies, Inc., Las Vegas, NV (US)

(72) Inventor: Jan Looney, Reno, NV (US)

(21) Appl. No.: 18/317,791

(22) Filed: May 15, 2023

Related U.S. Application Data
(60) Provisional application No. 63/490,741, filed on Mar. 16, 2023.

(51) Int. Cl. G07F 17/32; G06Q 50/34

(52) U.S. Cl. CPC G07F 17/3213; G06Q 50/34; G07F 17/3223; G07F 17/3237; G07F 17/329

(57) ABSTRACT

A gaming device is provided. The gaming device may include at least one processor, a memory, and a display device. The processor may: (1) cause the display device to display a lobby interface including a figure and a menu, the menu including a plurality of selectable denominations of a base game; (2) detect an input of credit to the gaming device by a user; (3) in response to detecting the input, display a first request text prompting the user to select from the plurality of selectable denominations; (4) parse the memory to identify (i) a first request audio file and (ii) a first request video file associated with the displayed first request text, the first request video file including a first request animation of the figure; and (5) cause the display device to (i) audibly play the first request audio file and (ii) display the first request video file.

### CROSS-REFERENCE TO RELATED APPLICATIONS

This application claims the benefit of priority to U.S. Provisional Patent Application Ser. No. 63/490,741, filed Mar. 16, 2023, and entitled “GAMING MACHINE AND METHOD FOR DISPLAYING A GAME LOBBY USER INTERFACE,” the contents and disclosures of which are hereby incorporated in their entirety.

### TECHNICAL FIELD

The field of disclosure relates generally to electronic gaming, and more particularly to an electronic gaming machine and for displaying a gaming lobby user interface.

### BACKGROUND

Electronic gaming machines (EGMs), or gaming devices, provide a variety of wagering games such as, for example, and without limitation, slot games, video poker games, video blackjack games, roulette games, video bingo games, keno games, and other types of games that are frequently offered at casinos and other locations. Play on EGMs typically involves a player establishing a credit balance by inserting or otherwise submitting money and placing a monetary wager (deducted from the credit balance) on one or more outcomes of an instance, or play, of a primary game, sometimes referred to as a base game. In many games, a player may qualify for secondary games or bonus rounds by attaining a certain winning combination or other triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

Slot games are often displayed to the player in the form of various symbols arranged in a row-by-column grid, or “matrix.” Specific matching combinations of symbols along predetermined paths, or paylines, drawn through the matrix indicate the outcome of the game. The display typically highlights winning combinations and outcomes for ready identification by the player. Matching combinations and their corresponding awards are usually shown in a “pay-table” that is available to the player for reference. Often, the player may vary his/her wager to include differing numbers of paylines and/or the amount bet on each line. By varying the wager, the player may sometimes alter the frequency or number of winning combinations, the frequency or number of secondary games, and/or the amount awarded.

Bingo games may also be played on electronic gaming machines. In some bingo games, a player receives a bingo card in response to a bingo game wager. A server, possibly after determining that enough players have entered the bingo game, may randomly determine and/or select a set of bingo numbers, and distribute the bingo numbers to the electronic gaming machines in the bingo game. The appropriate cells on the bingo card may be marked (or “daubed”) based on the bingo numbers.

Typical games use a random number generator (RNG) to randomly generate elements of the games (e.g., bingo cards, bingo numbers, slot symbol combinations) or to determine the outcome of each game. The game may be designed to return a certain percentage of the amount wagered back to the player, referred to as return to player (RTP), over the course of many plays or instances of the game. The RTP and randomness of the RNG are fundamental to ensuring the fairness of the games and are therefore highly regulated. The RNG may be used to randomly determine the outcome of a game and symbols may then be selected that correspond to that outcome. Alternatively, the RNG may be used to randomly select the symbols whose resulting combinations determine the outcome. Notably, some games may include an element of skill on the part of the player and are therefore not entirely random.

### SUMMARY

In one aspect, a gaming device is provided. The gaming device may include at least one processor, a memory, and a display device. The memory may store instructions that, when executed by the at least one processor, cause the at least one processor to: (1) cause the display device to display a lobby interface including a figure and a menu, the menu including a plurality of selectable denominations of a base game; (2) detect an input of credit to the gaming device by a user; (3) in response to detecting the input, display a first request text prompting the user to select from the plurality of selectable denominations; (4) parse the memory to identify (i) a first request audio file and (ii) a first request video file associated with the displayed first request text, the first request video file including a first request animation of the figure; and (5) cause the display device to (i) audibly play the first request audio file and (ii) display the first request video file including the figure and the first request animation of the figure within the lobby interface.

In another aspect a method for presenting a game lobby user interface is provided. The method may be performed by a gaming device including at least one processor, a memory, and a display device. The method may include (1) causing the display device to display a lobby interface including a figure and a menu, the menu including a plurality of selectable denominations of a base game; (2) detecting an input of credit to the gaming device by a user; (3) in response to detecting the input, displaying a first request text prompting the user to select from the plurality of selectable denominations; (4) parsing the memory to identify (i) a first request audio file and (ii) a first request video file associated with the displayed first request text, the first request video file including a first request animation of the figure; and (5) causing the display device to (i) audibly play the first request audio file and (ii) display the first request video file including the figure and the first request animation of the figure within the lobby interface.

In another aspect, at least one non-transitory computer-readable storage media having computer-executable instructions embodied thereon is provided. When executed by a gaming device including at least one processor, a memory, and a display device, the computer-executable instructions may cause the at least one processor to: (1) cause the display device to display a lobby interface including a figure and a menu, the menu including a plurality of selectable denominations of a base game; (2) detect an input of credit to the gaming device by a user; (3) in response to detecting the input, display a first request text prompting the user to select from the plurality of selectable denominations; (4) parse the memory to identify (i) a first request audio file and (ii) a first request video file associated with the displayed first request text, the first request video file including a first request animation of the figure; and (5) cause the display device to (i) audibly play the first request audio file and (ii) display the first request video file including the figure and the first request animation of the figure within the lobby interface.

### BRIEF DESCRIPTION OF THE DRAWINGS

An example embodiment of the subject matter disclosed will now be described with reference to the accompanying drawings.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A illustrates a game display according to an embodiment of the present disclosure that may be displayed by the gaming system shown in FIG. 1.

FIG. 4B illustrates further detail of the game display shown in FIG. 4A.

FIG. 4C illustrates further detail of the game display shown in FIGS. 4A and 4B.

FIG. 4D illustrates further detail of the game display shown in FIGS. 4A-4C.

FIG. 4E illustrates further detail of the game display shown in FIGS. 4A-4D.

FIG. 4F illustrates further detail of the game display shown in FIGS. 4A-4E.

### DETAILED DESCRIPTION

The systems and methods described herein include a gaming device, which may include a gaming lobby user interface. Some slot games and other electronic games require a user to select a denomination (e.g., an amount of currency per credit) for placing bets within the game. Because a user that is new to a game may not be familiar with the denomination selection process, the gaming lobby interface may include a figure and a menu including a plurality of selectable denominations. The figure may be an avatar, which may provide guidance and encouragement to a user during a denomination selection process. The figure may include text and/or animations, which may be accompanied by sounds (e.g., so it appears the figure is moving and/or speaking). The figure may be interactive, in that the text, animations, and sounds presented may be determined based on input or lack of input from the user. Accordingly, the game lobby user interface may provide information about denomination selection and/or other game selection processes (e.g., selecting a number of lines on which to bet, etc.) to the user in a way that, compared to traditional user interfaces, is more likely to be noticed and interacted with by the user. Further, by using a combination of text, animation, and sound, users with reduced eyesight and/or hearing may comprehend the user interface more easily.

In exemplary embodiments, the gaming device may detect an input of credit to the gaming device by the user. In response to detecting the input, the gaming device may display within the gaming lobby user interface a first request text prompting the user to select from the plurality of selectable denominations. The gaming device may further parse a memory to identify an audio file and/or a video file associated with the displayed text. For example, if the figure is an avatar with a human appearance, the audio file may include spoken audio of the text, and the video file may include an animation of the avatar to make it appear as if the avatar is speaking and/or reading aloud the audio of the text. In some embodiments, the avatar presented and/or the text spoken may be selected at random, to provide a greater variety of presentation experiences for the user within the user interface. For example, the text and associated audio and video may be selected randomly, from a plurality of candidate text options, based on an output of a random number generator. In some alternative embodiments, rather than being retrieved from a pre-recorded script, the text, sounds, and animations may be generated by a chatbot and/or artificial intelligence program (e.g., ChatGPT). In such embodiments, the text, sounds, and animations may nonetheless be synchronized, for example, to create the appearance that the avatar is reading the generated text aloud.

In some embodiments, additional text, audio, and/or video may be presented if the user does not respond (e.g., by selecting a denomination) to the initial prompt within a threshold period of time, with further text, audio, and/or video prompting the user to make a selection being presented periodically until a selection is made. The specific text associated with these additional prompts may also be determined randomly, so that the avatar's behaviour does not become repetitive. When the user makes a selection, additional text, audio, and/or video may be presented to provide a visual and/or audible confirmation of the selection. In some embodiments, the text displayed in associated with the confirmation may depend on the selection made (e.g., with the avatar making a more enthusiastic response for a selection of a higher denomination). Additionally, or alternatively, the confirmation text may be determined randomly from a plurality of candidate confirmation texts.

In some embodiments, the figure and accompanying text and/or sounds may be presented after gameplay has been initiated. In some such embodiments, the gaming device may determine that the credit level of the user is currently insufficient to place a certain bet at the current denomination. For example, the credit level may be too low to place any bet at the current denomination, or the credit level may be too low to place a maximum bet (e.g., a bet using all available pay lines) using the current denomination. In some game implementations, placing a maximum bet includes certain advantages such as increased chances at triggering a bonus game and/or jackpot. In either case, it may still be possible for the user to place a bet (e.g., a maximum bet) if the denomination is changed to a lower denomination. Accordingly, if the gaming device determines that the credit level of the user is currently insufficient to place a certain bet at the current denomination, the gaming device may display the figure and, in some examples, a menu for adjusting the denomination. The figure and accompanying text and/or sounds may provide instructions for selecting a new denomination, which may include the advantages (e.g., a better possible chance of triggering a bonus game or jackpot) in these situations.

The disclosed gaming systems and methods may provide one or more of the following technical benefits: (a) improving user accessibility of a user interface of a gaming device for providing instructions for denomination selection to a user by, in response to detecting an input of credit by a player, selecting a figure and accompanying text and/or audio instructions to present via the user interface; (b) improving variability of a user interface of a gaming device for providing instructions for denomination selection to a user by selecting, at least in part based on a script, random number generator outcome, and/or a chatbot-generated output, a figure and/or accompanying text and/or audio instructions to present via the user interface; (c) improving efficiency of area usage of a user interface of a gaming device for providing instructions for denomination selection to a user by presenting the instructions using a selected figure that may have accompanying text and/or audio; and/or (d) improving an ability for a user interface of a gaming device to provide instructions for changing a denomination during gameplay by automatically displaying a figure and accompanying text and/or audio instructions when the gaming device determines that the credit level of the user is currently insufficient to place a certain bet.

As used herein, the terms “primary game,” “main game,” and “base game” may refer to games initiated in response to one of a plurality of game initiation events, such as a wager or credit being received by or transferred to an EGM, as described herein. A primary game may be associated with a primary game outcome represented by a plurality of primary game symbols or primary game reels, each of which may include a plurality of primary game symbols, and each of which may be selected based upon a random number generated by a random number generator (e.g., in Class III games) or based on an evaluation of a bingo card and ball call (e.g., in Class II games).

Further, as used herein, the terms “secondary game,” “feature game,” and “bonus game” may refer generally to a game or a component of a game involving procedures in addition to the primary game. In some embodiments, a bonus game may be triggered from a primary game and may be associated with a bonus game outcome, which may be different from the primary game outcome. For example, a bonus game may be initiated after, or during, a primary game and in response to the occurrence of a particular condition, such as a “trigger condition” occurring during the primary game. A bonus game may result in a bonus game outcome or bonus award that increases a primary game award or adds a bonus game award to a primary game award.

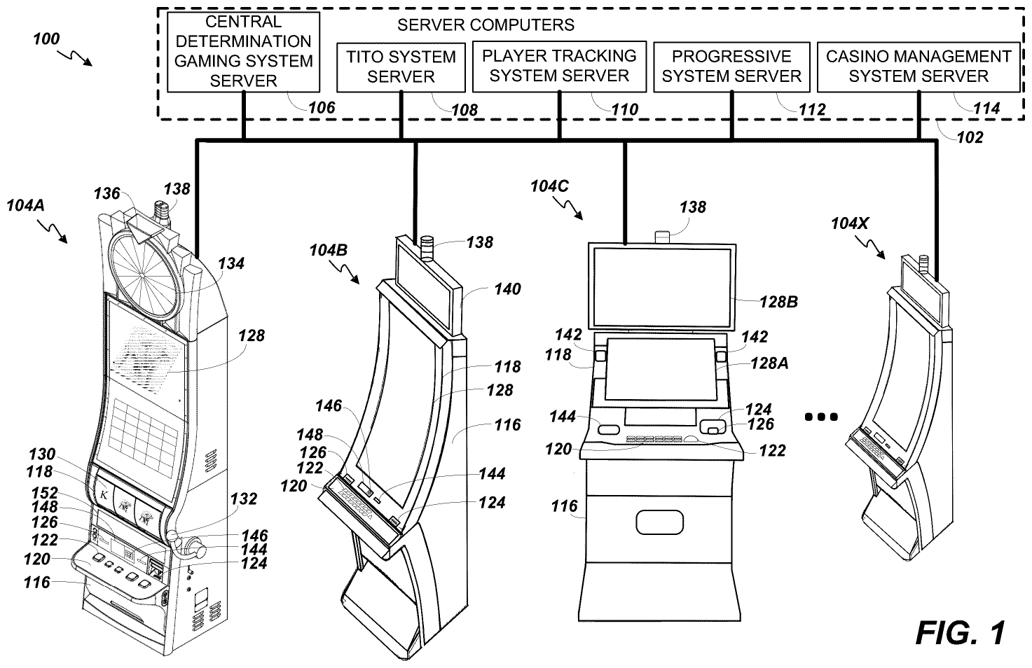

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards. Additionally, or alternatively, one or more of gaming devices 104A-104X may be configured as a tabletop game.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

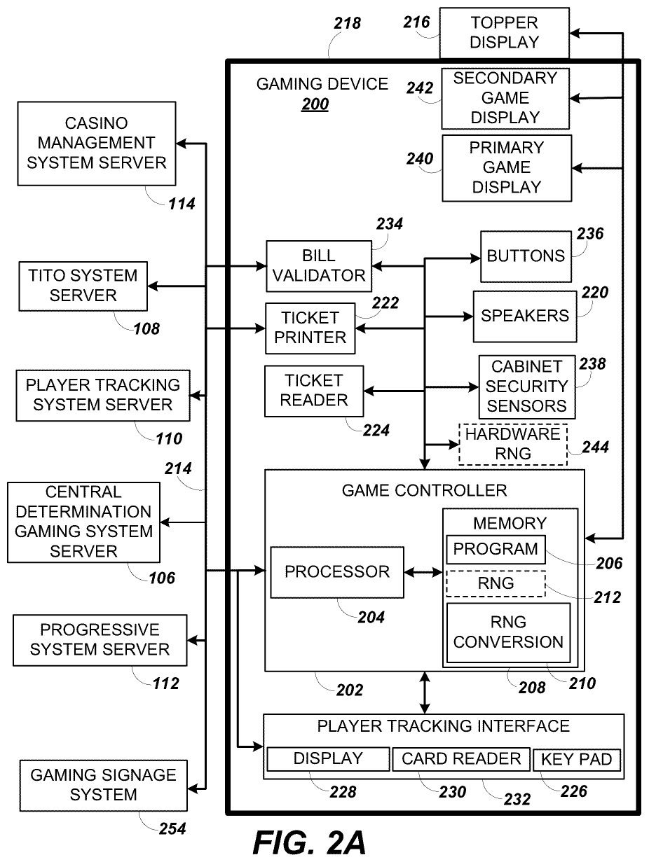

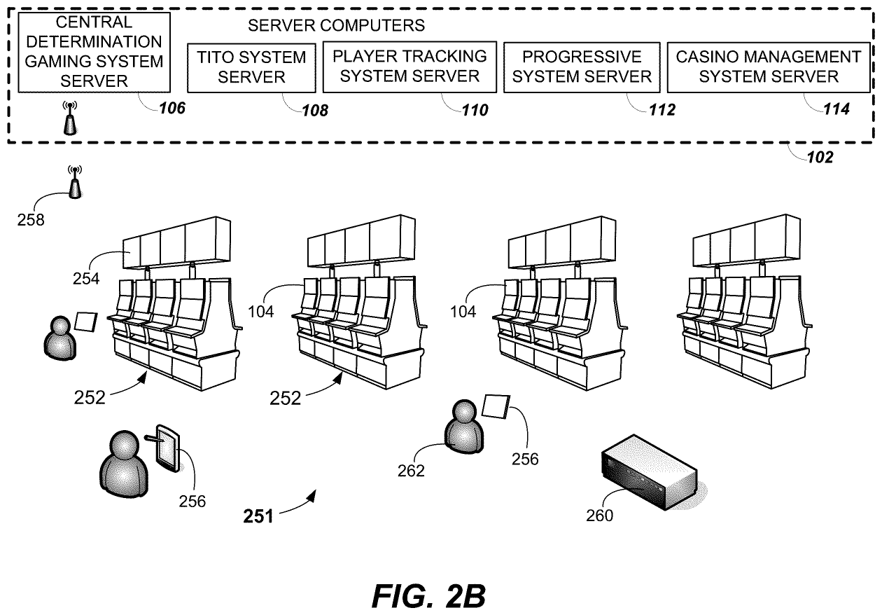

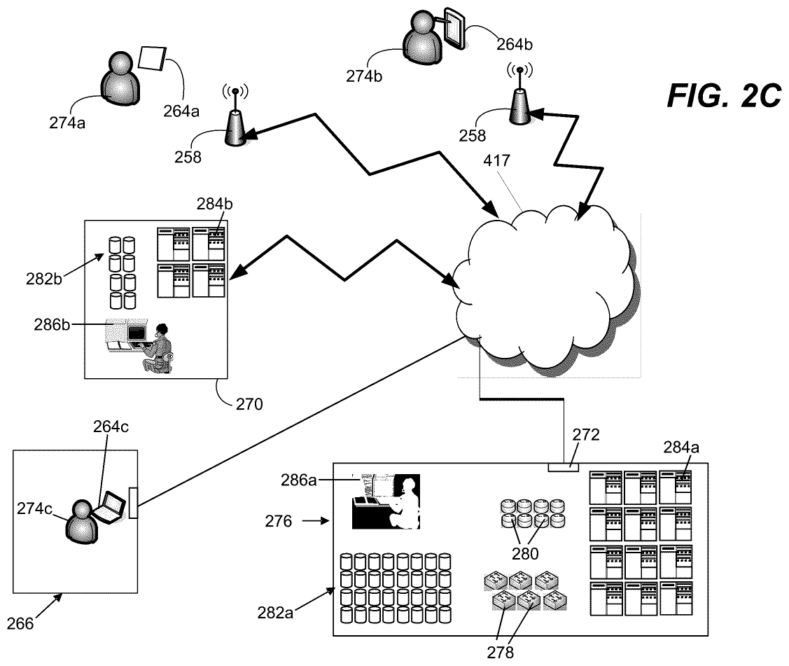

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

In an example embodiment, a tabletop EGM (not shown in FIG. 1) is provided which may be similar to the gaming devices 104. The tabletop EGM may include a horizontal display device that can be used by patrons as a conventional table surface as well as for providing player input (e.g., touchscreen surface, mechanical buttons, or the like) and display output (e.g., virtual wheel, virtual slot reels) for a tabletop game. The tabletop EGM may support participation for multiple players during game play (e.g., as patrons socially meet around the tabletop EGM). Example tabletop EGMs and features are described in greater detail below.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106. For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate case of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a. 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

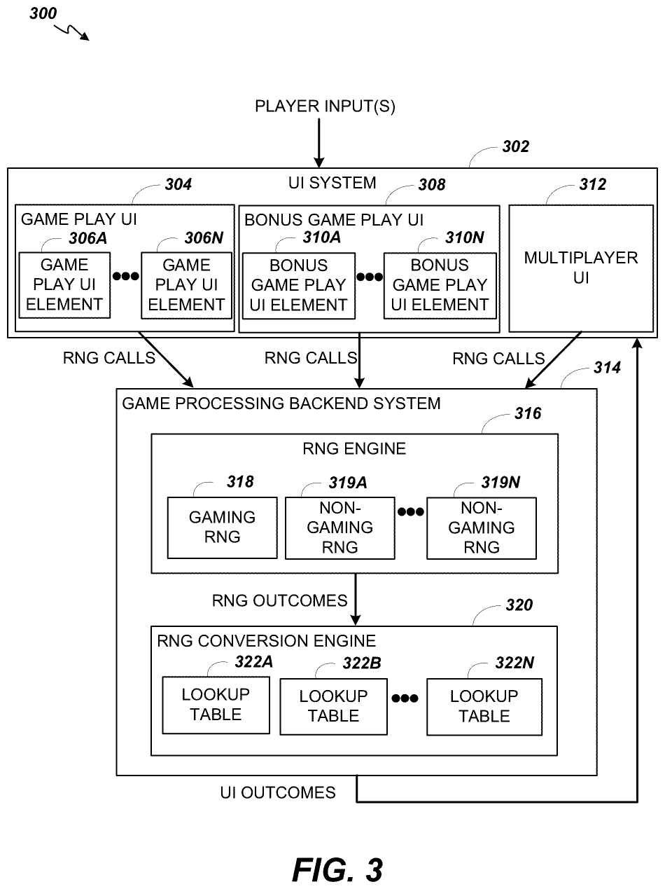

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

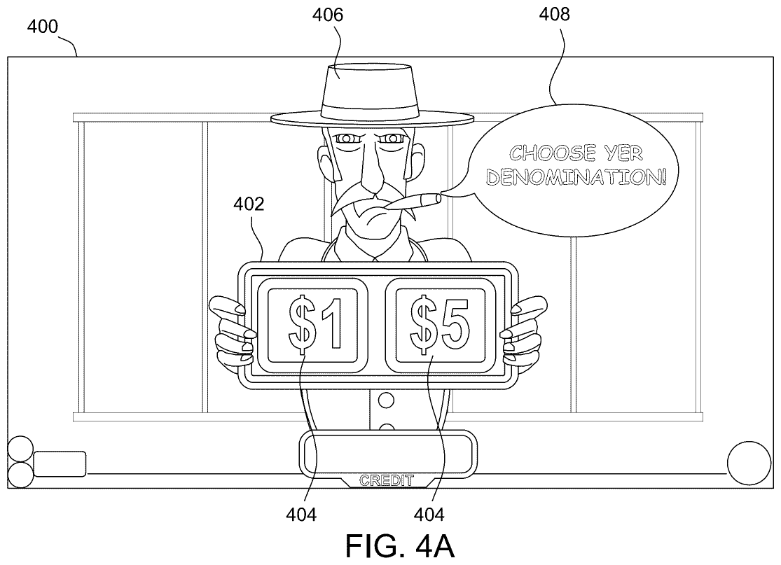

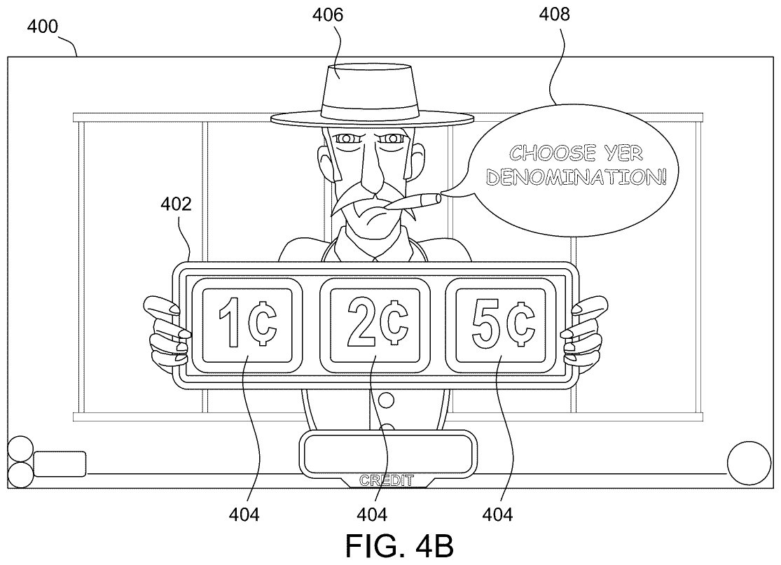

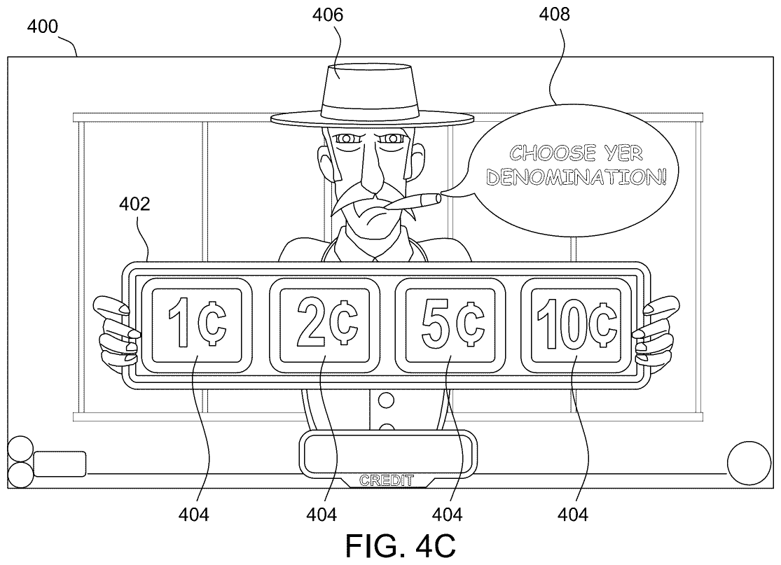

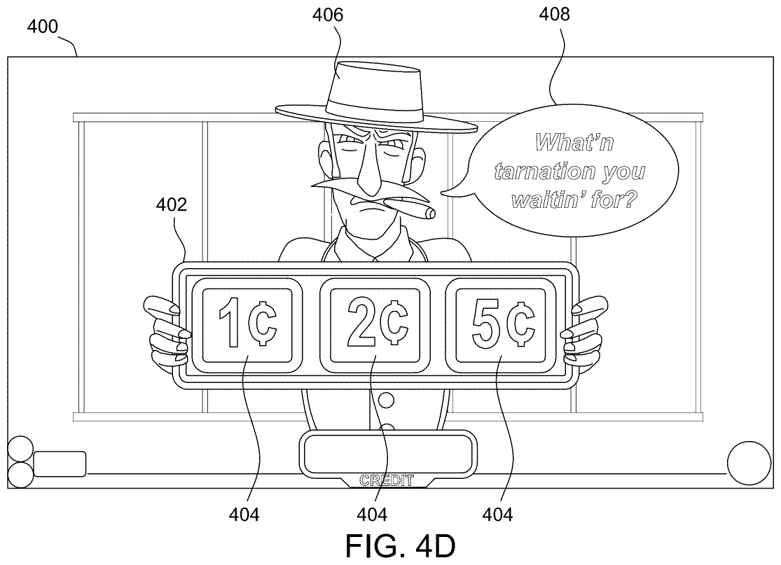

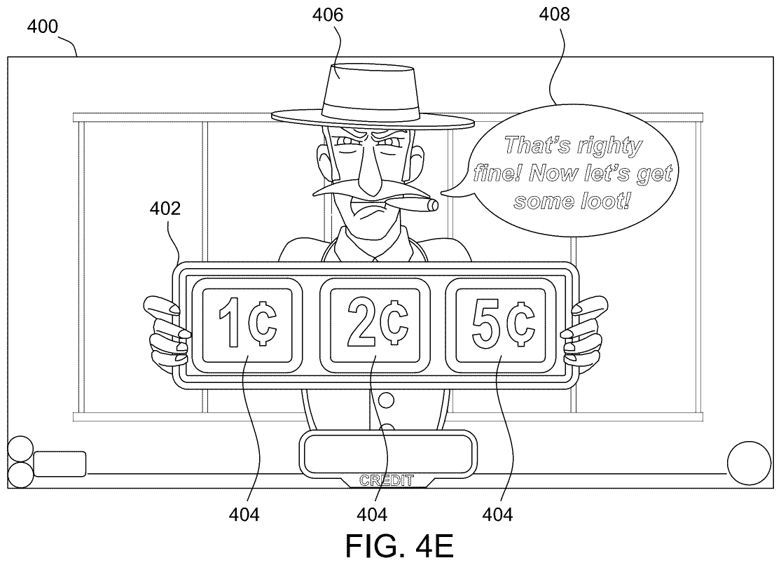

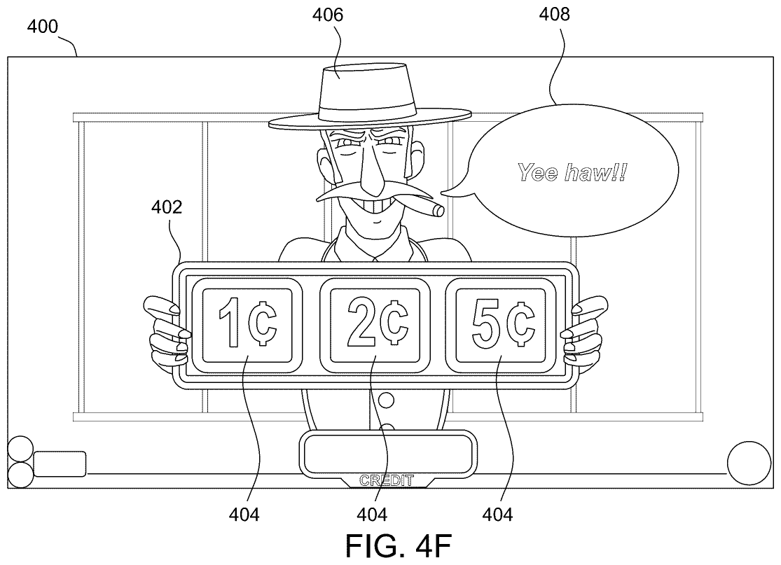

FIGS. 4A-4F depict an example gaming lobby user interface 400. Gaming lobby user interface 400 may be presented by gaming devices 104A-104X (shown in FIG. 1), for example, using primary game display 240 (shown in FIG. 2), based on internally stored instructions (e.g., stored in memory 208 shown in FIG. 2) or instructions received from one of servers 102 (shown in FIG. 1). Gaming lobby user interface 400 may be displayed when no gaming session is active and/or before the user has selected a denomination. Gaming lobby user interface 400 may include a menu 402 including a plurality of selectable denominations 404. Gaming lobby user interface 400 may further include an avatar 406 and a text balloon 408. The number of selectable denominations 404 and the specific values of the selectable denominations 404 may vary depending on the game that is presented by gaming devices 104A-104X, the loyalty status of the user, and/or other such factors. For example, menu 402 may include two, three, or four selectable denominations 404 (as shown in FIGS. 4A, 4B, and 4C, respectively). Similarly, the specific shape and design of menu 402, selectable denominations 404, and/or text balloon 408 may vary depending on the game that is presented by gaming devices 104A-104X, the loyalty status of the user, and/or other such factors. For example, the shape and design of menu 402, selectable denominations 404, and/or text balloon 408 may be selected to coincide with a theme of the game presented by gaming devices 104A-104X and/or the displayed avatar 406. Alternatively, in some embodiments, shape and design of menu 402, selectable denominations 404, and/or text balloon 408 may be similar or the same across different games, so that users familiar with menu 402 and/or selectable denominations 404 from one game may more easily recognize and/or understand menu 402, selectable denominations 404, and/or text balloon 408 from another game. In such embodiments, the same menu 402, selectable denominations 404, and/or text balloon 408 may be displayed even if different avatars 406 are used.

In the example embodiment, when gaming devices 104A-104X detect an input of credit to 104A-104X by the user, gaming devices 104A-104X may display a text (referred to herein as a “request text”) within text balloon 408 prompting the user to select from selectable denominations 404. In some embodiments, gaming devices 104A-104X may randomly select the request text from a plurality of candidate request texts based on an outcome of an RNG call. Alternatively, gaming devices 104A-104X may use another method for selecting the text to display, such as by cycling through the plurality of candidate request texts and/or selecting the request text based on predefined user preferences (e.g., associated with a loyalty account of the user). The language of the candidate texts, including the request text that is displayed, may fit a theme of the game and/or the displayed avatar 406. For example, if avatar 406 is a western outlaw, as shown in FIGS. 4A-4F, the request text may be aggressive (e.g., “CHOOSE YER DENOMINATION!” as shown in FIGS. 4A-4C). In embodiments in which a game may display one of a plurality of different avatars 406 at a given time, each avatar 406 may have a different script of candidate request texts from which the request text may be selected.

In some alternative embodiments, rather than being retrieved from a pre-recorded script, the text, sounds, and animations may be generated by a chatbot and/or artificial intelligence program (e.g., ChatGPT). In such embodiments, the text, sounds, and animations may nonetheless be synchronized, for example, to create the appearance that avatar 406 is reading the generated text aloud. In some such embodiments, historical interactions with the user may be used to determine the text, sounds, and video that is displayed. For example, avatar 406 may “criticize” a user for frequently selecting a low denomination.

In some embodiments, gaming devices 104A-104X may determine that the user has not made a selection from the plurality of selectable denominations after a first predefined period following detection of the credit input and/or the display of the first request text. In response to this determination, gaming devices 104A-104X may display another request text in text balloon 408 prompting the user to select from the plurality of selectable denominations. For example, FIG. 4D depicts the text “What'n tarnation you waitin' for” in text balloon 408, which may be displayed if the user has not made a selection after a certain period of time. Gaming devices 104A-104X may continue to display additional requests to select a denomination periodically until a selection is made by the user. At least some of the additional texts that are displayed may include language different from the language of the first request text. For example, each time an additional request text is displayed, the new request text may be selected from a plurality of candidate texts (e.g., randomly using an RNG and/or according to a script). In some such embodiments, each additional request text may include additional and/or more detailed instructions than the previous request text. For example, if the user has not made a selection after repeated prompts, the displayed texts may include instructions explaining why the user must select a denomination and/or the effects of selecting a particular denomination.

In some embodiments, when the user has made a selection, gaming devices 104A-104X may display another text (referred to herein as a “confirmation text”) in text balloon 408 to indicate that the selection has been made. For example, FIG. 4E depicts the text “That's righty fine! Now let's get some loot!” in text balloon 408, and FIG. 4F depicts the text “Yee haw !!” in text balloon 408, each of which may be displayed in response to the user selecting one of selectable denominations 404. Like the request texts, the confirmation text that is displayed may be selected by gaming devices 104A-104X from a plurality of candidate confirmation texts (e.g., randomly, based on a script, and/or based on user preferences). In some embodiments, the confirmation text that is displayed may depend on the denomination value that was selected. For example, selection of a higher denomination may result in a more enthusiastic message (e.g., the text shown in FIG. 4F) displayed.

In some embodiments, gaming devices 104A-104X may display a prompt to make another selection within gaming lobby user interface 400, such as a wager amount. For example, a number of paylines, a number of credits per payline, a number of credits per hand (in the case of, for example, a poker, keno, or black-jack game). In such embodiments, gaming lobby user interface 400 may further include one or more menus (which may be similar to menu 402) that include selectable options relating to the game aspect that is being selected. For example, if a number of credits per payline is to be selected, the menu may include selectable credit values, and/or if a number of paylines is to be selected, the menu may include selectable numbers of paylines. These selectable options may have a similar appearance to selectable denominations 404 within gaming lobby user interface 400, but may include text appropriate to the current prompt.

In such embodiments in which gaming devices 104A-104X may display a prompt to make another selection within gaming lobby user interface 400, the selectable menu and selectable options may also be accompanied by avatar 406 and text balloon 408, which may present text, sound, and animations similar to those described as presented with respect to a denomination selection, but may include text, sound, and animations appropriate for the current prompt. For example, the text, sound, and animations may prompt the user to select a number of paylines, a number of credits per payline, a number of credits per hand, and may provide other instructions, requests, or confirmation messages in relating to the current prompt. Similar to those associated with a denomination selection, files associated with such text, sound, and animations may be stored in, and retrieved from, a memory (e.g., memory 208 shown in FIG. 2).

In the example embodiment, when gaming devices 104A-104X display text in text balloon 408, gaming devices 104A-104X may parse a memory (e.g., memory 208 shown in FIG. 2 and/or another memory in communication with 104A-104X) to identify an audio file and/or a video file associated with the displayed text. For example, an audio file and/or a video file including a animation (referred to herein respectively as “a request audio file,” “a request video file,” and a “request animation”) may be associated with each request text stored in memory 208, and another audio file and/or another video file including an animation (referred to herein respectively as a “confirmation audio file.” “a confirmation video file,” and a “confirmation animation”) may be associated with each confirmation text stored in memory 208. The audio files may include speech (e.g., a recording of real speech and/or synthesized speech) associated with the displayed text, or other sounds relating to avatar 406 (e.g., barking if avatar 406 is a dog), which may be played by gaming devices 104A-104X when the text is displayed. The video files may include animations of avatar 406, which may be displayed simultaneously with playing the speech and/or other sounds to create an appearance that avatar 406 is speaking (e.g., by moving the lips of avatar 406 in sync with the speech) and/or making other sounds. Accordingly, the audio file may utilize a voice that corresponds thematically to avatar 406. For example, the western outlaw shown in FIG. 4 may be presented as speaking with a gruff voice. The video file may include other animations in addition to lip motion (e.g., moving, making gestures, etc.) and/or other visual effects (e.g., changes in the display background, etc.).

In some embodiments, the avatar 406 that is displayed may be selected from a plurality of candidate avatars 406 (sometimes also referred to herein as “candidate figures”). For example, a certain game presented by gaming devices 104A-104X may be associated with a plurality of candidate avatars 406, and when gameplay is initiated at one of gaming devices 104A-104X, one of the candidate avatars 406 may be selected (e.g., randomly based on an RNG call and/or according to a predefined sequence of avatars 406) for display. In some embodiments, user loyalty accounts may include user preferences, and the avatar 406 that is displayed may be selected based on these preferences. In some embodiments, users may design and/or save their own avatars 406, which may be displayed each time the user initiates a game (e.g., while logged in to the user's loyalty account). In some embodiments, each avatar 406 may be associated with certain text, such that the text that may be displayed in text balloon 408, and the audio files and video files associated with the text, may be selected based in part on the avatar 406 that is displayed. Accordingly, each avatar 406 may have a “personality,” which may coincide thematically with the game.

In addition to the initial denomination selection that is triggered upon beginning a gaming session, menu 402, avatar 406, and/or text balloon 408 may be displayed in response to other triggers. For example, avatar 406 may periodically be displayed during gameplay with accompanying text, sounds, and/or animations giving encouragement to the user (e.g., if the user meets some predefined in-game objective such as a threshold award). In some embodiments, gaming devices 104A-104X may determine that a credit balance of the user is insufficient for submitting a specified bet (e.g., a minimum or maximum bet) at a current denomination. For example, it may be beneficial for the user to place a maximum bet (e.g., to qualify for bonus awards, etc.). The user may have some credit remaining, but the remaining credit may not be sufficient to place, for example, a minimum or maximum bet at the current denomination. In response to this determination, gaming device 104A-104X may display gaming lobby user interface 400 including menu 402 and one or more selectable denominations 404, enabling the user to select a new denomination. For example, the user may select a lower denomination, which may enable the user to place a minimum or maximum bet with the remaining credit. In some such embodiments, when menu 402 is displayed, only proposed selectable denominations 404 that enable to place a further bet at the specified (e.g., minimum or maximum) bet level with the remaining credit are displayed.

In some embodiments, any voice bots or chatbots discussed herein may be configured to utilize artificial intelligence (AI) and/or machine learning (ML) techniques. For instance, the voice bot or chatbot may be a ChatGPT chatbot. The voice bot or chatbot may employ supervised or unsupervised machine learning techniques, which may be followed or used in conjunction with reinforced or reinforcement learning techniques. The voice bot or chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot is a software application used to conduct a chat conversation via text or text-to-speech, in lieu of providing direct contact with a live human agent. Chatbots are computer programs that are capable of maintaining a conversation with a user in natural language, understanding their intent, and replying based on preset rules and data, designed to convincingly simulate the way a human would behave as a conversational partner.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random-access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming device comprising at least one processor, a memory, and a display device, the memory storing instructions that, when executed by the processor, cause the at least one processor to:
cause the display device to display a lobby interface including a figure and a menu, the menu including a plurality of selectable denominations of a base game;
detect an input of credit to the gaming device by a user;
in response to detecting the input, display a first request text prompting the user to select from the plurality of selectable denominations;
parse the memory to identify (i) a first request audio file and (ii) a first request video file associated with the displayed first request text, the first request video file including a first request animation of the figure; and
cause the display device to (i) audibly play the first request audio file and (ii) display the first request video file including the figure and the first request animation of the figure within the lobby interface.

2. The gaming device of claim 1, wherein the instructions further cause the at least one processor to:
determine that a selection from the plurality of selectable denominations has not been made after a first predefined period following the detecting the input;
in response to the determination, display a second request text prompting the user to select from the plurality of selectable denominations;
parse the memory to identify a second request audio file and a second request video file associated with the displayed second request text, the second request video file including a second request animation of the figure; and
cause the display device to play the second request audio file and display the second request video file including the second request animation of the figure.

3. The gaming device of claim 2, wherein the first request text is different from the second request text, the first request audio file is different from the second request audio file, and the first request video file is different from the second request video file.

4. The gaming device of claim 1, wherein the instructions further cause the at least one processor to randomly select the first request text from a plurality of candidate request texts stored in the memory based on an outcome of a random number generator (RNG) call.

5. The gaming device of claim 1, wherein the instructions further cause the at least one processor to:
in response to receiving a selection from the plurality of selectable denominations, display a confirmation text;
parse the memory to identify a confirmation audio file and a confirmation video file associated with the displayed confirmation text, the confirmation video file including a confirmation animation of the figure; and
cause the display device to play the confirmation audio file and display the confirmation video file including the confirmation animation of the figure.

6. The gaming device of claim 5, wherein the instructions further cause the at least one processor to select the confirmation text based on the denomination selected by the user.

7. The gaming device of claim 5, wherein the instructions further cause the at least one processor to randomly select the confirmation text from a plurality of candidate confirmation texts based on an RNG call.

8. The gaming device of claim 1, wherein the instructions further cause the at least one processor to select the figure to display from a plurality of candidate figures.

9. The gaming device of claim 8, wherein the instructions further cause the at least one processor to randomly select the figure based on an outcome of an RNG call.

10. The gaming device of claim 8, wherein the instructions further cause the processor to select the figure based on a loyalty account associated with the user.

11. The gaming device of claim 9, wherein the instructions further cause the at least one processor to determine the first request text to display based on the selected figure.

12. The gaming device of claim 1, wherein the instructions further cause the at least one processor to:
determine that a credit balance of the user is insufficient for submitting a specified bet at a current denomination; and
in response to the determination, cause the display device to display the lobby interface including the figure and the menu including one or more of the plurality of selectable denominations, the one or more of the plurality of selectable denominations including at least one proposed denomination at which the determined credit balance is sufficient for submitting the specified bet.

13. The gaming device of claim 1, wherein the base game is a bingo game.

14. A method for presenting a game lobby user interface, the method performed by a gaming device including at least one processor, a memory, and a display device, said method comprising:
causing the display device to display a lobby interface including a figure and a menu, the menu including a plurality of selectable denominations of a base game;
detecting an input of credit to the gaming device by a user;
in response to detecting the input, displaying a first request text prompting the user to select from the plurality of selectable denominations;
parsing the memory to identify (i) a first request audio file and (ii) a first request video file associated with the displayed first request text, the first request video file including a first request animation of the figure; and
causing the display device to (i) audibly play the first request audio file and (ii) display the first request video file including the figure and the first request animation of the figure within the lobby interface.

15. The method of claim 14, further comprising:
determining that a selection from the plurality of selectable denominations has not been made after a first predefined period following the detecting the input;
in response to the determination, displaying a second request text prompting the user to select from the plurality of selectable denominations;
parsing the memory to identify a second request audio file and a second request video file associated with the displayed second request text, the second request video file including a second request animation of the figure; and
causing the display device to play the second request audio file and display the second request video file including the second request animation of the figure.

16. The method of claim 15, wherein the first request text is different from the second request text, the first request audio file is different from the second request audio file, and the first request video file is different from the second request video file.

17. The method of claim 14, further comprising selecting the first request text from a plurality of candidate request texts stored in the memory based on an outcome of a random number generator (RNG) call.

18. The method of claim 14, further comprising:
in response to receiving a selection from the plurality of selectable denominations, displaying a confirmation text;
parsing the memory to identify a confirmation audio file and a confirmation video file associated with the displayed confirmation text, the confirmation video file including a confirmation animation of the figure; and
causing the display device to play the confirmation audio file and display the confirmation video file including the confirmation animation of the figure.

19. The method of claim 14, further comprising:
determining that a credit balance of the user is insufficient for submitting a specified bet at a current denomination; and
in response to the determination, causing the display device to display the lobby interface including the figure and the menu including one or more of the plurality of selectable denominations, the one or more of the plurality of selectable denominations including at least one proposed denomination at which the determined credit balance is sufficient for submitting the specified bet.

20. At least one non-transitory computer-readable storage media having computer-executable instructions embodied thereon, wherein when executed by a gaming device including at least one processor, a memory, and a display device, the computer-executable instructions cause the at least one processor to:
cause the display device to display a lobby interface including a figure and a menu, the menu including a plurality of selectable denominations of a base game;
detect an input of credit to the gaming device by a user;
in response to detecting the input, display a first request text prompting the user to select from the plurality of selectable denominations;
parse the memory to identify (i) a first request audio file and (ii) a first request video file associated with the displayed first request text, the first request video file including a first request animation of the figure; and
cause the display device to (i) audibly play the first request audio file and (ii) display the first request video file including the figure and the first request animation of the figure within the lobby interface.
